(19) United States
(12) Patent Application Publication
(10) Pub. No.: US 2023/0038353 A1
(43) Pub. Date: Feb. 9, 2023

(54) MAGNETIC TAPE, MAGNETIC TAPE CARTRIDGE, AND MAGNETIC RECORDING AND REPRODUCING APPARATUS

(71) Applicant: FUJIFILM Corporation, Tokyo (JP)

(72) Inventor: Takashi IMAI, Minamiashigara-shi (JP)

(73) Assignee: FUJIFILM Corporation, Tokyo (JP)

(21) Appl. No.: 17/874,800

(22) Filed: Jul. 27, 2022

(30) Foreign Application Priority Data
Jul. 28, 2021 (JP) 2021-122855

(51) Int. Cl. G11B 5/706; G11B 5/735; G11B 5/78

(52) U.S. Cl. CPC G11B 5/70678; G11B 5/7356; G11B 5/78

(57) ABSTRACT

The magnetic tape includes a non-magnetic support, and a magnetic layer including a ferromagnetic powder. The non-magnetic support is a polyethylene naphthalate support, and a deformation rate ratio of a deformation rate in a width direction to a deformation rate in a longitudinal direction of the magnetic tape, (the deformation rate in the width direction/the deformation rate in the longitudinal direction), is 0.42 or less, the deformation rates each being measured after a load is applied in the longitudinal direction of the magnetic tape for 96 hours.

### CROSS-REFERENCE TO RELATED APPLICATIONS

This application claims priority under 35 U.S.C 119 to Japanese Patent Application No. 2021-122855 filed on Jul. 28, 2021. The above application is hereby expressly incorporated by reference, in its entirety, into the present application.

### BACKGROUND OF THE INVENTION

### 1. Field of the Invention

The present invention relates to a magnetic tape, a magnetic tape cartridge, and a magnetic recording and reproducing apparatus.

### 2. Description of the Related Art

A magnetic recording medium usually includes a magnetic layer and a non-magnetic support (see, for example, JP2001-011215A and JP2003-132523A).

### SUMMARY OF THE INVENTION

In both JP2001-011215A and JP2003-132523A, a Poisson's ratio is specified for a film used as a non-magnetic support of a magnetic recording medium. The Poisson's ratio is measured as a ratio of a deformation rate in the longitudinal direction to a deformation rate in a width direction, the deformation rate occurring in a case where the film is pulled in the longitudinal direction (see paragraphs 0083 to 0088 of JP2001-011215A and paragraphs 0058 and 0059 of JP2003-132523A).

On the other hand, there are two types of magnetic recording media: a tape shape and a disk shape, and a tape-shaped magnetic recording medium, that is, a magnetic tape is mainly used for data storage applications. As a result of the study by the present inventor regarding the magnetic tape, it has been found that a phenomenon such as recording failure (for example, overwriting of recorded data) or reproduction failure (for example, data reading failure) is observed in a case where a magnetic tape on which data is recorded is stored and then recording and/or reproduction is performed on the magnetic tape, and that it is difficult to suppress such a phenomenon by controlling the Poisson's ratio disclosed in JP2001-011215A and JP2003-132523A.

In view of the above, an object of an aspect of the present invention is to provide a magnetic tape capable of satisfactorily recording and/or reproducing data after storage.

One aspect of the present invention relates to a magnetic tape comprising: a non-magnetic support; and a magnetic layer including a ferromagnetic powder, in which the non-magnetic support is a polyethylene naphthalate support, and a deformation rate ratio of a deformation rate in a width direction to a deformation rate in a longitudinal direction of the magnetic tape, which is expressed by the deformation rate in the width direction/the deformation rate in the longitudinal direction, is 0.42 or less, the deformation rates each being measured after a load is applied in the longitudinal direction of the magnetic tape for 96 hours.

In one embodiment, the deformation rate ratio may be 0.15 or more and 0.42 or less.

In one embodiment, the magnetic tape may further comprise a non-magnetic layer including a non-magnetic powder between the non-magnetic support and the magnetic layer.

In one embodiment, the magnetic tape may further comprise a back coating layer including a non-magnetic powder on a surface side of the non-magnetic support opposite to a surface side having the magnetic layer.

In one embodiment, the ferromagnetic powder may be a hexagonal barium ferrite powder.

In one embodiment, the ferromagnetic powder may be a hexagonal strontium ferrite powder.

In one embodiment, the ferromagnetic powder may be an ε-iron oxide powder.

Another aspect of the present invention relates to a magnetic tape cartridge including the magnetic tape described above.

Still another aspect of the present invention relates to a magnetic recording and reproducing apparatus comprising the magnetic tape described above.

According to one aspect of the present invention, it is possible to provide a magnetic tape capable of satisfactorily recording and/or reproducing data after storage. In addition, according to one aspect of the present invention, it is possible to provide a magnetic tape cartridge and a magnetic recording and reproducing apparatus which include the magnetic tape.

### DESCRIPTION OF THE PREFERRED EMBODIMENTS

Magnetic Tape

One aspect of the present invention relates to a magnetic tape including a non-magnetic support and a magnetic layer including ferromagnetic powder. In the magnetic tape, the non-magnetic support is a polyethylene naphthalate support, and a deformation rate ratio of a deformation rate in a width direction to a deformation rate in a longitudinal direction of the magnetic tape, (the deformation rate in the width direction/the deformation rate in the longitudinal direction), is 0.42 or less, the deformation rates each being measured after a load is applied in the longitudinal direction of the magnetic tape for 96 hours.

Hereinafter, the magnetic tape will be described in more detail.

Non-Magnetic Support

The non-magnetic support of the magnetic tape is a polyethylene naphthalate support. In the present invention and the present specification, the term “polyethylene naphthalate” (PEN) means a polyester containing a naphthalene ring, and the term “polyester” means a resin containing a plurality of ester bonds. Polyethylene naphthalate is a resin that can be obtained by performing esterification reaction of dimethyl 2,6-naphthalenedicarboxylate and ethylene glycol, followed by transesterification and polycondensation reaction. The term “polyethylene naphthalate” in the present invention and the present specification includes those having a structure having one or more other components (for example, a copolymer component, a component introduced into a terminal or a side chain, or the like) in addition to the above component. The term “polyethylene naphthalate support” means a support including at least one layer of polyethylene naphthalate film. The term “polyethylene naphthalate film” refers to a film in which a component that occupies the largest amount on a mass basis among components constituting the film is polyethylene naphthalate. The term “polyethylene naphthalate support” in the present invention and the present specification includes those in which all resin films included in the support are polyethylene naphthalate films, and those including the polyethylene naphthalate film and another resin film. Specific aspects of the polyethylene naphthalate support include a single-layer polyethylene naphthalate film, a laminated film of two or more polyethylene naphthalate films having the same constituent components, a laminated film of two or more polyethylene naphthalate films having different constituent components, a laminated film including one or more polyethylene naphthalate films and one or more resin films other than the polyethylene naphthalate film, and the like. An adhesive layer or the like may be optionally included between two adjacent layers in the laminated film.

Deformation Rate Ratio

In the study by the present inventor to obtain a magnetic tape capable of satisfactorily recording and/or reproducing data after storage, the present inventor has newly found that in a magnetic tape including a polyethylene naphthalate support, the above deformation rate ratio of 0.42 or less can contribute to satisfactorily recording and/or reproducing data on the magnetic tape after storage. The deformation rate ratio is obtained by the following method.

A magnetic tape to be measured is stored for 24 hours or more in a storage environment of an atmosphere temperature of 23° C. and a relative humidity of 50%, and then subjected to the following measurement. The magnetic tape accommodated in a magnetic tape cartridge is stored in the above storage environment together with the magnetic tape cartridge.

As a measuring device, a device capable of measuring a length and a width of the magnetic tape in a state where a load is applied in the longitudinal direction of the magnetic tape is used. As such a device, for example, a measuring device (TDSMS 102H) manufactured by Measurement Analysis Corporation (U.S.A) can be used.

The measurement is performed in a measurement environment of an atmosphere temperature of 32° C. and a relative humidity of 65%. A tape piece having a length of 600 mm in the longitudinal direction is cut out from any position of the magnetic tape after the storage. The cut out tape piece is set in the measuring device. In a case where an atmosphere temperature and a relative humidity of an environment in which the measuring device in which the tape piece is set is placed are the atmosphere temperature and the relative humidity of the measurement environment described above, the tape piece is held in a state where a load of 0.20 N (Newton) is applied in the longitudinal direction of the tape piece after 30 minutes or more have elapsed since the tape piece is set in the measuring device. In a case where an atmosphere temperature and a relative humidity of an environment in which the measuring device is placed are different from the atmosphere temperature and the relative humidity of the measurement environment described above, the temperature and the humidity are adjusted such that the atmosphere temperature and the relative humidity of this environment are the atmosphere temperature and the relative humidity of the measurement environment described above. After 30 minutes or more have elapsed since an atmosphere temperature and a relative humidity of an environment in which the measuring device in which the tape piece is set is placed reached the atmosphere temperature and the relative humidity of the measurement environment described above by the temperature and humidity adjustment, the tape piece is held in a state where a load of 0.20 N (Newton) is applied in the longitudinal direction of the tape piece.

A dimension in the width direction (that is, width) and a dimension in the longitudinal direction (that is, length) of the tape piece are measured when 30 minutes have elapsed with a start time of the application of a load of 0.20 N set to 0 minutes. The dimensions in the width direction and the longitudinal direction can be measured by a measuring device unit (for example, a laser scan micrometer) attached to the measuring device. The same applies to the measurement of the dimensions described below. The dimension in the width direction measured here is defined as an initial value “W₀” in the width direction, and the dimension in the longitudinal direction is defined as an initial value “L₀” in the longitudinal direction.

After 30 minutes have elapsed from the start of the application of a load of 0.20 N, a load applied in the longitudinal direction is set to 0.55 N, and a load of 0.55 N is applied for 96 hours.

After applying a load of 0.55 N in the longitudinal direction for 96 hours, a load applied in the longitudinal direction is changed to 0.20 N and held in a state where a load of 0.20 N is applied. The dimension in the width direction and the dimension in the longitudinal direction of the tape piece are measured when 5 minutes have elapsed after the load is changed to 0.20 N. The dimension in the width direction measured here is denoted by “W₉₆”, and the dimension in the longitudinal direction is denoted by “L₉₆”. The reason why the load is set to 0.20 N at the start time of the application of the load is to hold the tape piece so that the slack does not occur. On the other hand, the reason why the above measurement is performed by applying a load of 0.20 N in the longitudinal direction after applying a load of 0.55 N for 96 hours is to measure the residual strain after the application of the load of 0.55 N for 96 hours. The present inventor considers that this residual strain includes irreversible creep and/or reversible strain with a long time constant.

A deformation rate in the width direction of the magnetic tape measured after applying a load in the longitudinal direction of the magnetic tape for 96 hours is calculated from W₉₆ and W₀ measured above as a value obtained by dividing an absolute value of a difference between W₉₆ and W₀ by W₀ and multiplying the result by 10⁶ (deformation rate in width direction=|W₉₆−W₀|/W₀×10⁶). The unit of the deformation rate in the width direction and a deformation rate in the longitudinal direction below is parts per million (ppm). In calculating the deformation rate in the width direction, W₉₆ and W₀ are set to the same unit value. In calculating a deformation rate in the longitudinal direction below, L₉₆ and L₀ are set to the same unit value. The unit is, for example, “mm”.

A deformation rate in the longitudinal direction of the magnetic tape measured after applying a load in the longitudinal direction of the magnetic tape for 96 hours is calculated from L₉₆ and L₀ measured above as a value obtained by dividing an absolute value of a difference between L₉₆ and L₀ by L₀ and multiplying the result by 10⁶ (deformation rate in longitudinal direction=|L₉₆−L₀|/L₀×10⁶).

The deformation rate ratio is calculated as a ratio of the deformation rate in the width direction to the deformation rate in the longitudinal direction (the deformation rate in the width direction/the deformation rate in the longitudinal direction).

The above deformation rate ratio is significantly different from a deformation rate ratio of the width direction to the longitudinal direction, which is generally called a Poisson's ratio. Supposition of the present inventor regarding this point is described below. Note that the present invention is not limited to the supposition described in the present specification.

As described above, the deformation rate ratio can be said to be an index of deformation characteristics of the magnetic tape to which a load is applied for a long time of 96 hours. The load application time of 96 hours is a value employed as an example of a storage time in a case where a magnetic tape after data recording described below is stored, and does not limit the storage period of the magnetic tape at all.

On the other hand, a Poisson's ratio is a measured value for a phenomenon observed in a short time (within several minutes at the longest) in which a so-called viscoelastic body such as a magnetic tape is considered to behave elastically. The present inventor considers that such Poisson's ratio cannot be an index of deformation characteristics of the magnetic tape that occur during storage of the magnetic tape, which is considered to behave more viscously. In fact, as shown in Examples described below, no correlation was found between the above-described deformation rate ratio and a deformation rate ratio of the width direction to the longitudinal direction under a load applied for a short time.

The present inventor considers that in a magnetic tape including a polyethylene naphthalate support, the above deformation rate ratio of 0.42 or less can contribute to suppressing a phenomenon that, in a case where the magnetic tape on which data is recorded is stored and then recording and/or reproduction is performed, the magnetic head for recording and/or reproducing data deviates from a target track position due to deformation of the magnetic tape, and the data is recorded and/or reproduced. This point will be further described in more detail below.

Recording and reproduction of data on a magnetic tape are usually performed as follows. The magnetic tape is run in a magnetic recording and reproducing apparatus (generally called a “drive”). During such running, head tracking using servo signals is performed. Specifically, by making the reading element of the servo signal of the magnetic head follow a predetermined servo track of the magnetic tape, the recording element for recording data is controlled to pass on the target data track, and the data is recorded. Displacement of the data track is performed by changing a servo track read by the servo signal reading element in a tape width direction. In a case of reproducing the recorded data, usually, the magnetic tape is run in the magnetic recording and reproducing apparatus, and the servo signal reading element of the magnetic head is made to follow a predetermined servo track of the magnetic tape, so that the reproducing element for reproducing data is controlled to pass on the target data track, and the recorded data is read. After such recording or reproduction, the magnetic tape is usually stored until the next recording and/or reproduction is performed.

During the recording and/or reproduction is performed after the storage, in a case where the magnetic head for recording and/or reproducing data records and/or reproduces data while being deviated from a target track position due to deformation of the magnetic tape, a phenomenon such as recording failure (for example, overwriting of recorded data) or reproduction failure (for example, data reading failure) may occur. The present inventor considers that a magnetic tape including a polyethylene naphthalate support and having a deformation rate ratio of 0.42 or less is a magnetic tape that is less likely to undergo deformation that can cause such a phenomenon. As a result, according to the magnetic tape, the present inventor suppose that it is possible to satisfactorily perform recording and/or reproducing data on the magnetic tape after storage. In recent years, in the field of data storage, there is an increasing need for long-term storage of data, such as data backup and archiving. However, in general, as a storage period increases, the magnetic tape tends to be easily deformed. Therefore, the present inventor considers that a magnetic tape capable of suppressing the occurrence of the above phenomenon after storage is preferable because it can be said to be a magnetic tape that can meet the needs for long-term storage in the future.

The deformation rate ratio of the magnetic tape is 0.42 or less, and, from the viewpoint of enabling more satisfactorily performing recording and/or reproducing data after storage, is preferably 0.41 or less, and is more preferably 0.39 or less, 0.37 or less, 0.35 or less, 0.33 or less, 0.31 or less, 0.29 or less, 0.27 or less, and 0.25 or less in this order. The deformation rate ratio may be, for example, 0.10 or more or 0.15 or more, or may be lower than the value exemplified here.

The deformation rate ratio can be controlled by, for example, the manufacturing conditions of the magnetic tape. This point will be described below in detail.

In a case where the deformation rate ratio of the magnetic tape is 0.42 or less, the value of the deformation rate in the width direction and the value of the deformation rate in the longitudinal direction of the magnetic tape measured after applying a load in the longitudinal direction for 96 hours are particularly limited. The deformation rate in the width direction may be, for example, less than 30 ppm, 29 ppm or less, 27 ppm or less, 25 ppm or less, 23 ppm or les, 21 ppm or less, or 19 ppm or less, and may be, for example, 5 ppm or more, 7 ppm or more, or 9 ppm or more. In addition, the deformation rate in the longitudinal direction may be, for example, 100 ppm or less or 98 ppm or less, and may be, for example, 20 ppm or more, 25 ppm or more, or 30 ppm or more.

The non-magnetic support may be subjected to one or more treatments such as a corona discharge, a plasma treatment, and an easy-bonding treatment before a layer such as a magnetic layer is formed thereon.

Magnetic Layer

Ferromagnetic Powder

A magnetic layer includes a ferromagnetic powder. As a ferromagnetic powder included in the magnetic layer, a well-known ferromagnetic powder as a ferromagnetic powder used in magnetic layers of various magnetic recording media can be used. From the viewpoint of improving recording density, it is preferable to use a ferromagnetic powder having a small average particle size. From this point, the average particle size of the ferromagnetic powder is preferably 50 nm or less, more preferably 45 nm or less, still more preferably 40 nm or less, still more preferably 35 nm or less, still more preferably 30 nm or less, and still more preferably 25 nm or less. On the other hand, from the viewpoint of magnetization stability, the average particle size of the ferromagnetic powder is preferably 5 nm or more, more preferably 8 nm or more, still more preferably 10 nm or more, still more preferably 15 nm or more, and still more preferably 20 nm or more.

Hexagonal Ferrite Powder

As a preferred specific example of the ferromagnetic powder, a hexagonal ferrite powder can be used. For details of the hexagonal ferrite powder, for example, descriptions disclosed in paragraphs 0012 to 0030 of JP2011-225417A, paragraphs 0134 to 0136 of JP2011-216149A, paragraphs 0013 to 0030 of JP2012-204726A, and paragraphs 0029 to 0084 of JP2015-127985A can be referred to.

In the present invention and the present specification, the term “hexagonal ferrite powder” refers to a ferromagnetic powder in which a hexagonal ferrite crystal structure is detected as a main phase by X-ray diffraction analysis. The main phase refers to a structure to which the highest intensity diffraction peak in an X-ray diffraction spectrum obtained by X-ray diffraction analysis is attributed. For example, in a case where the highest intensity diffraction peak is attributed to a hexagonal ferrite crystal structure in an X-ray diffraction spectrum obtained by X-ray diffraction analysis, it is determined that the hexagonal ferrite crystal structure is detected as the main phase. In a case where only a single phase is detected by X-ray diffraction analysis, this detected structure is taken as the main phase. The hexagonal ferrite crystal structure includes at least an iron atom, a divalent metal atom, and an oxygen atom, as a constituent atom. The divalent metal atom is a metal atom that can be a divalent cation as an ion, and examples thereof may include an alkaline earth metal atom such as a strontium atom, a barium atom, and a calcium atom, and a lead atom. In the present invention and the present specification, a hexagonal strontium ferrite powder refers to a powder in which a main divalent metal atom is a strontium atom, and a hexagonal barium ferrite powder refers to a powder in which a main divalent metal atom is a barium atom. The main divalent metal atom refers to a divalent metal atom that accounts for the most on an at % basis among the divalent metal atoms included in the powder. Note that a rare earth atom is not included in the above divalent metal atom. The term “rare earth atom” in the present invention and the present specification is selected from the group consisting of a scandium atom (Sc), an yttrium atom (Y), and a lanthanoid atom. The lanthanoid atom is selected from the group consisting of a lanthanum atom (La), a cerium atom (Ce), a praseodymium atom (Pr), a neodymium atom (Nd), a promethium atom (Pm), a samarium atom (Sm), a europium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

Hereinafter, the hexagonal strontium ferrite powder, which is an aspect of the hexagonal ferrite powder, will be described in more detail.

An activation volume of the hexagonal strontium ferrite powder is preferably in a range of 800 to 1500 nm³. The finely granulated hexagonal strontium ferrite powder having an activation volume in the above range is suitable for manufacturing a magnetic tape exhibiting excellent electromagnetic conversion characteristics. The activation volume of the hexagonal strontium ferrite powder is preferably 800 nm³ or more, and may be, for example, 850 nm³ or more. From the viewpoint of further improving the electromagnetic conversion characteristics, the activation volume of the hexagonal strontium ferrite powder is more preferably 1400 nm³ or less, still more preferably 1300 nm³ or less, still more preferably 1200 nm³ or less, and still more preferably 1100 nm³ or less.

The term “activation volume” refers to a unit of magnetization reversal and is an index indicating the magnetic size of a particle. An activation volume described in the present invention and the present specification and an anisotropy constant Ku which will be described below are values obtained from the following relational expression between a coercivity Hc and an activation volume V, by performing measurement in a coercivity Hc measurement portion at a magnetic field sweep rate of 3 minutes and 30 minutes using a vibrating sample magnetometer (measurement temperature: 23° C.±1° C.). For a unit of the anisotropy constant Ku, 1 erg/cc=1.0×10⁻¹ J/m³.

Hc=2Ku/Ms{1−[(kT/KuV)ln(At/0.693)]^{1/2}}

[In the above expression, Ku: anisotropy constant (unit: J/m³), Ms: saturation magnetization (Unit: kA/m), k: Boltzmann constant, T: absolute temperature (unit: K), V: activation volume (unit: cm³), A: spin precession frequency (unit: s⁻¹), t: magnetic field reversal time (unit: s)]

An index for reducing thermal fluctuation, in other words, for improving the thermal stability may include the anisotropy constant Ku. The hexagonal strontium ferrite powder preferably has Ku of 1.8×10⁵ J/m³ or more, and more preferably has Ku of 2.0×10⁵ J/m³ or more. Ku of the hexagonal strontium ferrite powder may be, for example, 2.5×10⁵ J/m³ or less. Here, since higher Ku means higher thermal stability, which is preferable, a value thereof is not limited to the values exemplified above.

The hexagonal strontium ferrite powder may or may not include a rare earth atom. In a case where the hexagonal strontium ferrite powder includes a rare earth atom, it is preferable to include a rare earth atom at a content (bulk content) of 0.5 to 5.0 at % with respect to 100 at % of an iron atom. In one aspect, the hexagonal strontium ferrite powder including a rare earth atom may have a rare earth atom surface layer portion uneven distribution property. In the present invention and the present specification, the “rare earth atom surface layer portion uneven distribution property” means that a rare earth atom content with respect to 100 at % of an iron atom in a solution obtained by partially dissolving the hexagonal strontium ferrite powder with an acid (hereinafter, referred to as a “rare earth atom surface layer portion content” or simply a “surface layer portion content” for a rare earth atom) and a rare earth atom content with respect to 100 at % of an iron atom in a solution obtained by totally dissolving the hexagonal strontium ferrite powder with an acid (hereinafter, referred to as a “rare earth atom bulk content” or simply a “bulk content” for a rare earth atom) satisfy a ratio of a rare earth atom surface layer portion content/a rare earth atom bulk content>1.0. A rare earth atom content in the hexagonal ferrite powder described below is synonymous with the rare earth atom bulk content. On the other hand, partial dissolution using an acid dissolves a surface layer portion of a particle constituting the hexagonal strontium ferrite powder, and thus, a rare earth atom content in a solution obtained by partial dissolution is a rare earth atom content in a surface layer portion of a particle constituting the hexagonal strontium ferrite powder. A rare earth atom surface layer portion content satisfying a ratio of “rare earth atom surface layer portion content/rare earth atom bulk content>1.0” means that in a particle constituting the hexagonal strontium ferrite powder, rare earth atoms are unevenly distributed in a surface layer portion (that is, more than an inside). The surface layer portion in the present invention and the present specification means a partial region from a surface of a particle constituting the hexagonal strontium ferrite powder toward an inside.

In a case where the hexagonal ferrite powder includes the rare earth atom, a rare earth atom content (bulk content) is preferably in a range of 0.5 to 5.0 at % with respect to 100 at % of an iron atom. It is considered that a bulk content in the above range of the included rare earth atom and uneven distribution of the rare earth atoms in a surface layer portion of a particle constituting the hexagonal strontium ferrite powder contribute to suppression of a decrease in reproduction output during repeated reproduction. It is supposed that this is because the hexagonal strontium ferrite powder includes a rare earth atom with a bulk content in the above range, and rare earth atoms are unevenly distributed in a surface layer portion of a particle constituting the hexagonal strontium ferrite powder, and thus it is possible to increase an anisotropy constant Ku. The higher a value of an anisotropy constant Ku is, the more a phenomenon called thermal fluctuation can be suppressed (in other words, thermal stability can be improved). By suppressing occurrence of thermal fluctuation, it is possible to suppress a decrease in reproduction output during repeated reproduction. It is supposed that uneven distribution of rare earth atoms in a particulate surface layer portion of the hexagonal strontium ferrite powder contributes to stabilization of spins of iron (Fe) sites in a crystal lattice of a surface layer portion, and thus, an anisotropy constant Ku may be increased.

Moreover, it is supposed that the use of the hexagonal strontium ferrite powder having a rare earth atom surface layer portion uneven distribution property as a ferromagnetic powder in the magnetic layer also contributes to inhibition of a magnetic layer surface from being scraped by being slid with respect to the magnetic head. That is, it is supposed that the hexagonal strontium ferrite powder having a rare earth atom surface layer portion uneven distribution property can also contribute to an improvement of running durability of the magnetic tape. It is supposed that this may be because uneven distribution of rare earth atoms on a surface of a particle constituting the hexagonal strontium ferrite powder contributes to an improvement of interaction between the particle surface and an organic substance (for example, a binding agent and/or an additive) included in the magnetic layer, and, as a result, a strength of the magnetic layer is improved.

From the viewpoint of further suppressing a decrease in reproduction output during repeated reproduction and/or the viewpoint of further improving running durability, the rare earth atom content (bulk content) is more preferably in a range of 0.5 to 4.5 at %, still more preferably in a range of 1.0 to 4.5 at %, and still more preferably in a range of 1.5 to 4.5 at %.

The bulk content is a content obtained by totally dissolving the hexagonal strontium ferrite powder. In the present invention and the present specification, unless otherwise noted, the content of an atom means a bulk content obtained by totally dissolving the hexagonal strontium ferrite powder. The hexagonal strontium ferrite powder including a rare earth atom may include only one kind of rare earth atom as the rare earth atom, or may include two or more kinds of rare earth atoms. The bulk content in the case of including two or more types of rare earth atoms is obtained for the total of two or more types of rare earth atoms. This also applies to other components in the present invention and the present specification. That is, unless otherwise noted, a certain component may be used alone or in combination of two or more. A content amount or a content in a case where two or more components are used refers to that for the total of two or more components.

In a case where the hexagonal strontium ferrite powder includes a rare earth atom, the included rare earth atom need only be any one or more of rare earth atoms. As a rare earth atom that is preferable from the viewpoint of further suppressing a decrease in reproduction output during repeated reproduction, there are a neodymium atom, a samarium atom, a yttrium atom, and a dysprosium atom, here, the neodymium atom, the samarium atom, and the yttrium atom are more preferable, and a neodymium atom is still more preferable.

In the hexagonal strontium ferrite powder having a rare earth atom surface layer portion uneven distribution property, the rare earth atoms need only be unevenly distributed in the surface layer portion of a particle constituting the hexagonal strontium ferrite powder, and the degree of uneven distribution is not limited. For example, for the hexagonal strontium ferrite powder having a rare earth atom surface layer portion uneven distribution property, a ratio of a surface layer portion content of a rare earth atom obtained by partial dissolution under dissolution conditions which will be described below to a bulk content of a rare earth atom obtained by total dissolution under dissolution conditions which will be described below, that is, “surface layer portion content/bulk content” exceeds 1.0 and may be 1.5 or more. The fact that “surface layer portion content/bulk content” is larger than 1.0 means that in a particle constituting the hexagonal strontium ferrite powder, rare earth atoms are unevenly distributed in the surface layer portion (that is, more than an inside). Further, a ratio of a surface layer portion content of a rare earth atom obtained by partial dissolution under dissolution conditions which will be described below to a bulk content of a rare earth atom obtained by total dissolution under the dissolution conditions which will be described below, that is, “surface layer portion content/bulk content” may be, for example, 10.0 or less, 9.0 or less, 8.0 or less, 7.0 or less, 6.0 or less, 5.0 or less, or 4.0 or less. Note that, in the hexagonal strontium ferrite powder having a rare earth atom surface layer portion uneven distribution property, the rare earth atoms need only be unevenly distributed in the surface layer portion of a particle constituting the hexagonal strontium ferrite powder, and the “surface layer portion content/bulk content” is not limited to the exemplified upper limit or lower limit.

The partial dissolution and the total dissolution of the hexagonal strontium ferrite powder will be described below. For the hexagonal strontium ferrite powder that exists as a powder, the partially and totally dissolved sample powder is taken from the same lot of powder. On the other hand, for the hexagonal strontium ferrite powder included in the magnetic layer of the magnetic tape, a part of the hexagonal strontium ferrite powder taken out from the magnetic layer is subjected to partial dissolution, and the other part is subjected to total dissolution. The hexagonal strontium ferrite powder can be taken out from the magnetic layer by a method described in a paragraph 0032 of JP2015-91747A, for example.

The partial dissolution means that dissolution is performed such that, at the end of dissolution, the residue of the hexagonal strontium ferrite powder can be visually checked in the solution. For example, by partial dissolution, it is possible to dissolve a region of 10 to 20 mass % of the particle constituting the hexagonal strontium ferrite powder with the total particle being 100 mass %. On the other hand, the total dissolution means that dissolution is performed such that, at the end of dissolution, the residue of the hexagonal strontium ferrite powder cannot be visually checked in the solution.

The partial dissolution and measurement of the surface layer portion content are performed by the following method, for example. Note that the following dissolution conditions such as the amount of sample powder are exemplified, and dissolution conditions for partial dissolution and total dissolution can be employed in any manner.

A container (for example, a beaker) containing 12 mg of the sample powder and 10 ml of 1 mol/L hydrochloric acid is held on a hot plate at a set temperature of 70° C. for 1 hour. The obtained solution is filtered by a membrane filter of 0.1 μm. Elemental analysis of the filtrated solution thus obtained is performed by an inductively coupled plasma (ICP) analyzer. In this way, the surface layer portion content of a rare earth atom with respect to 100 at % of an iron atom can be obtained. In a case where a plurality of kinds of rare earth atoms are detected by elemental analysis, the total content of all rare earth atoms is defined as the surface layer portion content. This also applies to the measurement of the bulk content.

On the other hand, the total dissolution and measurement of the bulk content are performed by the following method, for example.

A container (for example, a beaker) containing 12 mg of the sample powder and 10 ml of 4 mol/L hydrochloric acid is held on a hot plate at a set temperature of 80° C. for 3 hours. Thereafter, the same procedure as the partial dissolution and the measurement of the surface layer portion content is carried out, and the bulk content with respect to 100 at % of an iron atom can be obtained.

From the viewpoint of increasing the reproduction output in a case of reproducing data recorded on the magnetic tape, it is desirable that mass magnetization σs of the ferromagnetic powder included in the magnetic tape is high. In this regard, the hexagonal strontium ferrite powder including a rare earth atom but not having the rare earth atom surface layer portion uneven distribution property tends to have a larger decrease in as than that of the hexagonal strontium ferrite powder including no rare earth atom. With respect to this, it is considered that the hexagonal strontium ferrite powder having a rare earth atom surface layer portion uneven distribution property is preferable in suppressing such a large decrease in σs. In one aspect, σs of the hexagonal strontium ferrite powder may be 45 A·m²/kg or more, and may be 47 A·m²/kg or more. On the other hand, from the viewpoint of noise reduction, σs is preferably 80 A·m²/kg or less and more preferably 60 A·m²/kg or less. σs can be measured using a well-known measuring device, such as a vibrating sample magnetometer, capable of measuring magnetic properties. In the present invention and the present specification, unless otherwise noted, the mass magnetization σs is a value measured at a magnetic field intensity of 1194 kA/m (15 kOe).

Regarding the content (bulk content) of a constituent atom of the hexagonal ferrite powder, a strontium atom content may be, for example, in a range of 2.0 to 15.0 at % with respect to 100 at % of an iron atom. In one aspect, the hexagonal strontium ferrite powder may include only a strontium atom as a divalent metal atom. In another aspect, the hexagonal strontium ferrite powder can also include one or more kinds of other divalent metal atoms, in addition to the strontium atom. For example, a barium atom and/or a calcium atom may be included. In a case where the other divalent metal atoms other than the strontium atom are included, a content of the barium atom and a content of the calcium atom in the hexagonal strontium ferrite powder respectively can be, for example, in a range of 0.05 to 5.0 at % with respect to 100 at % of the iron atom.

As the hexagonal ferrite crystal structure, a magnetoplumbite type (also referred to as an “M type”), a W type, a Y type, and a Z type are known. The hexagonal strontium ferrite powder may have any crystal structure. The crystal structure can be checked by X-ray diffraction analysis. In the hexagonal strontium ferrite powder, a single crystal structure or two or more crystal structures may be detected by X-ray diffraction analysis. For example, according to an aspect, in the hexagonal strontium ferrite powder, only the M-type crystal structure may be detected by X-ray diffraction analysis. For example, M-type hexagonal ferrite is represented by a composition formula of AFe₁₂O₁₉. Here, A represents a divalent metal atom, and in a case where the hexagonal strontium ferrite powder is the M-type, A is only a strontium atom (Sr), or in a case where, as A, a plurality of divalent metal atoms are included, as described above, a strontium atom (Sr) accounts for the most on an at % basis. The divalent metal atom content of the hexagonal strontium ferrite powder is usually determined by the type of crystal structure of the hexagonal ferrite and is not particularly limited. The same applies to the iron atom content and the oxygen atom content. The hexagonal strontium ferrite powder may include at least an iron atom, a strontium atom, and an oxygen atom, and may further include a rare earth atom. Furthermore, the hexagonal strontium ferrite powder may or may not include atoms other than these atoms. As an example, the hexagonal strontium ferrite powder may include an aluminum atom (Al). A content of an aluminum atom may be, for example, 0.5 to 10.0 at % with respect to 100 at % of an iron atom. From the viewpoint of further suppressing a decrease in reproduction output during repeated reproduction, the hexagonal strontium ferrite powder includes an iron atom, a strontium atom, an oxygen atom, and a rare earth atom, and the content of atoms other than these atoms is preferably 10.0 at % or less, more preferably in a range of 0 to 5.0 at %, and may be 0 at % with respect to 100 at % of an iron atom. That is, in one aspect, the hexagonal strontium ferrite powder may not include atoms other than an iron atom, a strontium atom, an oxygen atom, and a rare earth atom. The content expressed in at % is obtained by converting a content of each atom (unit: mass %) obtained by totally dissolving the hexagonal strontium ferrite powder into a value expressed in at % using an atomic weight of each atom. Further, in the present invention and the present specification, the term “not include” for a certain atom means that a content measured by an ICP analyzer after total dissolution is 0 mass %. A detection limit of the ICP analyzer is usually 0.01 parts per million (ppm) or less on a mass basis. The term “not included” is used as a meaning including that an atom is included in an amount less than the detection limit of the ICP analyzer. In one aspect, the hexagonal strontium ferrite powder may not include a bismuth atom (Bi).

Metal Powder

Preferred specific examples of the ferromagnetic powder include a ferromagnetic metal powder. For details of the ferromagnetic metal powder, descriptions disclosed in paragraphs 0137 to 0141 of JP2011-216149A and paragraphs 0009 to 0023 of JP2005-251351A can be referred to, for example.

ε-Iron Oxide Powder

Preferred specific examples of the ferromagnetic powder include an ε-iron oxide powder. In the present invention and the present specification, the term “ε-iron oxide powder” refers to a ferromagnetic powder in which an ε-iron oxide crystal structure is detected as a main phase by X-ray diffraction analysis. For example, in a case where the highest intensity diffraction peak is attributed to an ε-iron oxide crystal structure in an X-ray diffraction spectrum obtained by X-ray diffraction analysis, it is determined that the ε-iron oxide crystal structure is detected as the main phase. As a method of manufacturing an ε-iron oxide powder, a producing method from a goethite, a reverse micelle method, and the like are known. All of the manufacturing methods are well known. Regarding a method of manufacturing an ε-iron oxide powder in which a part of Fe is substituted with substitutional atoms such as Ga, Co, Ti, Al, or Rh, a description disclosed in J. Jpn. Soc. Powder Metallurgy Vol. 61 Supplement, No. S1, pp. S280 to S284, J. Mater. Chem. C, 2013, 1, pp. 5200 to 5206 can be referred to, for example. Note that the method of manufacturing the ε-iron oxide powder capable of being used as the ferromagnetic powder in the magnetic layer of the magnetic tape is not limited to the methods described here.

An activation volume of the ε-iron oxide powder is preferably in a range of 300 to 1500 nm³. The finely granulated ε-iron oxide powder having an activation volume in the above range is suitable for manufacturing a magnetic tape exhibiting excellent electromagnetic conversion characteristics. The activation volume of the ε-iron oxide powder is preferably 300 nm³ or more, and may be, for example, 500 nm³ or more. Further, from the viewpoint of further improving the electromagnetic conversion characteristics, the activation volume of the ε-iron oxide powder is more preferably 1400 nm³ or less, still more preferably 1300 nm³ or less, still more preferably 1200 nm³ or less, and still more preferably 1100 nm³ or less.

An index for reducing thermal fluctuation, in other words, for improving the thermal stability may include the anisotropy constant Ku. The ε-iron oxide powder preferably has Ku of 3.0×10⁴ J/m³ or more, and more preferably has Ku of 8.0×10⁴ J/m³ or more. Ku of the ε-iron oxide powder may be, for example, 3.0×10⁵ J/m³ or less. Here, since higher Ku means higher thermal stability, which is preferable, a value thereof is not limited to the values exemplified above.

From the viewpoint of increasing the reproduction output in a case of reproducing data recorded on the magnetic tape, it is desirable that mass magnetization σs of the ferromagnetic powder included in the magnetic tape is high. In this regard, in one aspect, σs of the ε-iron oxide powder may be 8 A·m²/kg or more, and may be 12 A·m²/kg or more. On the other hand, from the viewpoint of noise reduction, σs of the ε-iron oxide powder is preferably 40 A·m²/kg or less and more preferably 35 A·m²/kg or less.

In the present invention and the present specification, unless otherwise noted, an average particle size of various powders such as ferromagnetic powders is a value measured by the following method using a transmission electron microscope.

The powder is imaged at an imaging magnification of 100,000× with a transmission electron microscope, the image is printed on photographic printing paper or displayed on a display so that the total magnification of 500,000× to obtain an image of particles configuring the powder. A target particle is selected from the obtained image of particles, an outline of the particle is traced by a digitizer, and a size of the particle (primary particle) is measured. The primary particles are independent particles without aggregation.

The measurement described above is performed regarding 500 particles randomly extracted. An arithmetic average of the particle sizes of 500 particles thus obtained is an average particle size of the powder. As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. An average particle size shown in Examples which will be described below is a value measured by using a transmission electron microscope H-9000 manufactured by Hitachi, Ltd. as the transmission electron microscope, and image analysis software KS-400 manufactured by Carl Zeiss as the image analysis software, unless otherwise noted. In the present invention and the present specification, the powder means an aggregate of a plurality of particles. For example, the ferromagnetic powder means an aggregate of a plurality of ferromagnetic particles. Further, the aggregate of the plurality of particles not only includes an aspect in which particles constituting the aggregate directly come into contact with each other, but also includes an aspect in which a binding agent or an additive which will be described below is interposed between the particles. The term “particle” is used to describe a powder in some cases.

As a method of taking a sample powder from the magnetic tape in order to measure the particle size, a method disclosed in a paragraph 0015 of JP2011-048878A can be employed, for example.

In the present invention and the present specification, unless otherwise noted, (1) in a case where the shape of the particle observed in the particle image described above is a needle shape, a fusiform shape, or a columnar shape (here, a height is greater than a maximum long diameter of a bottom surface), the size (particle size) of the particles configuring the powder is shown as a length of a long axis configuring the particle, that is, a long axis length, (2) in a case where the shape of the particle is a plate shape or a columnar shape (here, a thickness or a height is smaller than a maximum long diameter of a plate surface or a bottom surface), the particle size is shown as a maximum long diameter of the plate surface or the bottom surface, and (3) in a case where the shape of the particle is a sphere shape, a polyhedron shape, or an unspecified shape, and the long axis configuring the particles cannot be specified from the shape, the particle size is shown as an equivalent circle diameter. The equivalent circle diameter is a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetic average of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, and in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably in a range of 50 to 90 mass % and more preferably in a range of 60 to 90 mass %, with respect to the total mass of the magnetic layer. A high filling percentage of the ferromagnetic powder in the magnetic layer is preferable from the viewpoint of improving the recording density.

Binding Agent

The magnetic tape can be a coating type magnetic tape and can include the binding agent in the magnetic layer. That is, in one aspect, a metal thin film type magnetic tape is removed from the magnetic tape. As is known, the metal thin film type magnetic tape is a magnetic tape having a ferromagnetic metal thin film layer formed by vacuum vapor deposition, sputtering, ion plating, or the like as a magnetic layer.

The binding agent is one or more kinds of resins. As the binding agent, various resins usually used as a binding agent of a coating type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins may be homopolymers or copolymers. These resins can be used as the binding agent even in a non-magnetic layer and/or a back coating layer which will be described below. For the above binding agent, descriptions disclosed in paragraphs 0028 to 0031 of JP2010-24113A and paragraphs 0006 to 0021 of JP2004-5795A can be referred to. An average molecular weight of the resin used as the binding agent can be, for example, 10,000 to 200,000 as a weight-average molecular weight. The average molecular weight of the present invention and the present specification is a value obtained by performing polystyrene conversion of a value measured by gel permeation chromatography (GPC) under the following measurement conditions. The average molecular weight of the binding agent shown in Examples described below is a value obtained by performing polystyrene conversion of a value measured under the following measurement conditions. The binding agent may be used in an amount of, for example, 1.0 to 80.0 parts by mass with respect to 100.0 parts by mass of the ferromagnetic powder. For the amount of the binding agent in the non-magnetic layer and the back coating layer, the description regarding the amount of the binding agent in the magnetic layer can be applied by replacing the ferromagnetic powder with the non-magnetic powder.

GPC device: HLC-8120 (manufactured by Tosoh Corporation)

Column: TSKgel Multipore HXL-M (manufactured by Tosoh Corporation, 7.8 mm inner diameter (ID)×30.0 cm)

Eluent: tetrahydrofuran (THF)

A curing agent can also be used together with the resin which can be used as the binding agent. As the curing agent, in one aspect, a thermosetting compound which is a compound in which curing reaction (crosslinking reaction) proceeds due to heating can be used, and in another aspect, a photocurable compound in which a curing reaction (crosslinking reaction) proceeds due to light irradiation can be used. The curing reaction proceeds in a magnetic layer forming step, whereby at least a part of the curing agent can be included in the magnetic layer in a state of being reacted (crosslinked) with other components such as the binding agent. The same applies to the layer formed using this composition in a case where the composition used to form the other layer includes a curing agent. The preferred curing agent is a thermosetting compound, and polyisocyanate is suitable for this. For details of the polyisocyanate, descriptions disclosed in paragraphs 0124 and 0125 of JP2011-216149A can be referred to. The content of the curing agent in a magnetic layer forming composition may be, for example, 0 to 80.0 parts by mass, and from the viewpoint of improving a strength of the magnetic layer, may be 50.0 to 80.0 parts by mass, with respect to 100.0 parts by mass of the binding agent. The same applies to a non-magnetic layer forming composition and a back coating layer forming composition.

Additive

The magnetic layer may include one or more kinds of additives, as necessary. As the additives, the curing agent described above is used as an example. In addition, examples of the additive which can be included in the magnetic layer include a non-magnetic powder (for example, an inorganic powder or carbon black), a lubricant, a dispersing agent, a dispersing assistant, an antibacterial agent, an antistatic agent, an antioxidant, and the like. For example, for the lubricant, descriptions disclosed in paragraphs 0030 to 0033, 0035, and 0036 of JP2016-126817A can be referred to. The non-magnetic layer may include a lubricant. For the lubricant that can be included in the non-magnetic layer, descriptions disclosed in paragraphs 0030, 0031, 0034, 0035, and 0036 of JP2016-126817A can be referred to. For the dispersing agent, descriptions disclosed in paragraphs 0061 and 0071 of JP2012-133837A can be referred to. For the additive of the magnetic layer, descriptions disclosed in paragraphs 0035 to 0077 of JP2016-51493A can be referred to. The dispersing agent may be added to a non-magnetic layer forming composition. For the dispersing agent that can be added to the non-magnetic layer forming composition, a description disclosed in a paragraph 0061 of JP2012-133837A can be referred to. As the non-magnetic powder that can be included in the magnetic layer, a non-magnetic powder which can function as an abrasive, or a non-magnetic powder which can function as a protrusion forming agent which forms protrusions appropriately protruded from the magnetic layer surface (for example, non-magnetic colloidal particles) is used. An average particle size of colloidal silica (silica colloidal particles) shown in Examples described below is a value obtained by a method disclosed as a measurement method of an average particle diameter in a paragraph 0015 of JP2011-048878A. As the additive, a commercially available product can be suitably selected or manufactured by a well-known method according to the desired properties, and any amount thereof can be used. As an example of the additive which can be used for improving dispersibility of the abrasive in the magnetic layer including the abrasive, a dispersing agent disclosed in paragraphs 0012 to 0022 of JP2013-131285A can be used.

The magnetic layer described above can be provided on a surface of the non-magnetic support directly or indirectly through the non-magnetic layer.

Non-Magnetic Layer

Next, the non-magnetic layer will be described. The above magnetic tape may have a magnetic layer directly on the surface of the non-magnetic support, or may have a magnetic layer on the surface of the non-magnetic support through a non-magnetic layer including a non-magnetic powder. The non-magnetic powder used in the non-magnetic layer may be an inorganic powder or an organic powder. In addition, the carbon black and the like can be used. Examples of the inorganic powder include powders of metal, metal oxide, metal carbonate, metal sulfate, metal nitride, metal carbide, and metal sulfide. The non-magnetic powder can be purchased as a commercially available product or can be manufactured by a well-known method. For details thereof, descriptions disclosed in paragraphs 0146 to 0150 of JP2011-216149A can be referred to. For carbon black which can be used in the non-magnetic layer, descriptions disclosed in paragraphs 0040 and 0041 of JP2010-24113A can be referred to. The content (filling percentage) of the non-magnetic powder of the non-magnetic layer is preferably in a range of 50 to 90 mass % and more preferably in a range of 60 to 90 mass %, with respect to the total mass of the non-magnetic layer.

The non-magnetic layer can include a binding agent, and can also include an additive, as necessary. In regards to other details of a binding agent or an additive of the non-magnetic layer, a well-known technology regarding the non-magnetic layer can be applied. In addition, in regards to the type and the content of the binding agent, and the type and the content of the additive, for example, the well-known technology regarding the magnetic layer can be applied.

The non-magnetic layer of the present invention and the present specification also includes a substantially non-magnetic layer including a small amount of ferromagnetic powder as impurities or intentionally, together with the non-magnetic powder. Here, the substantially non-magnetic layer is a layer having a residual magnetic flux density equal to or smaller than 10 mT, a layer having a coercivity equal to or smaller than 7.96 kA/m (100 Oe), or a layer having a residual magnetic flux density equal to or smaller than 10 mT and a coercivity equal to or smaller than 7.96 kA/m (100 Oe). It is preferable that the non-magnetic layer does not have a residual magnetic flux density and coercivity.

Back Coating Layer

The magnetic tape may or may not have a back coating layer including a non-magnetic powder on a surface side of the non-magnetic support opposite to a surface side having the magnetic layer. The back coating layer preferably contains any one or both of carbon black and an inorganic powder. As the carbon black, for example, carbon black having an average particle size of 17 nm or more and 50 nm or less (hereinafter, referred to as “fine particle carbon black”) can be used, and carbon black having an average particle size of more than 50 nm and 300 nm or less (hereinafter, referred to as “coarse particle carbon black”) can be used. Further, fine particle carbon black and coarse particle carbon black can be used in combination.

Examples of the inorganic powder include a non-magnetic powder generally used for the non-magnetic layer and a non-magnetic powder generally used as an abrasive for the magnetic layer, and among them, α-iron oxide, α-alumina, and the like are preferable. The average particle size of the inorganic powder in the back coating layer may be, for example, in a range of 5 to 250 nm. In a case where the carbon black and the inorganic powder are used in combination as the non-magnetic powder of the back coating layer, in one aspect, the inorganic powder is preferably included in an amount of more than 50.0 parts by mass, and more preferably included in an amount of 70.0 to 90.0 parts by mass, with respect to the total amount of the non-magnetic powder of 100.0 parts by mass. In one aspect, the description regarding the non-magnetic powder of the back coating layer can be applied to the non-magnetic powder of the non-magnetic layer.

The back coating layer can include a binding agent, and can also include an additive, as necessary. Regarding the binding agent and additive in the back coating layer, a well-known technology for the back coating layer can be applied, and a well-known technology for the formulation of the magnetic layer and/or the non-magnetic layer can also be applied. For example, for the back coating layer, descriptions disclosed in paragraphs 0018 to 0020 of JP2006-331625A and page 4, line 65, to page 5, line 38, of U.S. Pat. No. 7,029,774B can be referred to.

Various Thicknesses

A thin thickness of the magnetic tape is preferable from the viewpoint of increasing the capacity of one roll of a magnetic tape cartridge. Reducing a thickness of the non-magnetic support is preferable because it may lead to reduction in thickness of the magnetic tape. From this point, the thickness of the non-magnetic support included in the magnetic tape is preferably less than 10.0 μm, more preferably 9.0 μm or less, still more preferably 8.0 μm or less, still more preferably 7.0 μm or less, and still more preferably 6.0 μm or less. Further, the thickness of the non-magnetic support may be, for example, 0.5 μm or more or 1.0 μm or more.

A thickness of the magnetic layer can be optimized according to a saturation magnetization amount, a head gap length, and a band of a recording signal of the used magnetic head, is generally 0.01 μm to 0.15 μm, and, from the viewpoint of high-density recording, is preferably 0.015 μm to 0.12 μm and more preferably 0.02 μm to 0.1 μm. The magnetic layer need only be at least a single layer, the magnetic layer may be separated into two or more layers having different magnetic properties, and a configuration of a well-known multilayered magnetic layer can be applied as the magnetic layer. A thickness of the magnetic layer in a case where the magnetic layer is separated into two or more layers is a total thickness of the layers.

A thickness of the non-magnetic layer is, for example, 0.1 to 1.5 μm, and preferably 0.1 to 1.0 μm.

A thickness of the back coating layer is preferably 0.9 μm or less and more preferably 0.1 to 0.7 μm.

The thickness of the non-magnetic support and the thickness of each layer in the present invention and the present specification can be obtained by a well-known method. For example, the thickness of the magnetic layer can be obtained by the following method. After exposing a cross section of the magnetic tape in a thickness direction by a well-known method such as an ion beam or a microtome, a cross section image of the exposed cross section is acquired by a scanning electron microscope (SEM) or a transmission electron microscope (TEM). Cross section images are acquired for ten randomly selected locations. A thickness of the magnetic layer is measured at one location randomly selected from each of the ten images acquired in this way. In this way, a thickness of the magnetic layer can be obtained as an arithmetic average of ten measurement values obtained for ten images. In a case of obtaining a thickness of the magnetic layer, an interface between the magnetic layer and an adjacent portion (for example, the non-magnetic layer) can be specified by a method disclosed in a paragraph 0029 of JP2017-33617A. Other thicknesses can be obtained in the same manner. Alternatively, the various thicknesses can be obtained as a designed thickness calculated according to manufacturing conditions.

Manufacturing Step

Preparation of Each Layer Forming Composition

A step of preparing a composition for forming the magnetic layer, the non-magnetic layer, or the back coating layer can usually include at least a kneading step, a dispersing step, and, as necessary, a mixing step provided before and after these steps. Each step may be divided into two or more stages. Components used for the preparation of each layer forming composition may be added at an initial stage or in a middle stage of each step. As a solvent, one kind or two or more kinds of various solvents generally used for manufacturing a coating type magnetic recording medium can be used. For the solvent, for example, a description disclosed in a paragraph 0153 of JP2011-216149A can be referred to. In addition, each component may be separately added in two or more steps. For example, a binding agent may be added separately in a kneading step, a dispersing step, and a mixing step for adjusting a viscosity after dispersion. In order to manufacture the magnetic tape, a well-known manufacturing technology can be used in various steps. In the kneading step, an open kneader, a continuous kneader, a pressure kneader, or a kneader having a strong kneading force such as an extruder is preferably used. For details of the kneading step, descriptions disclosed in JP1989-106338A (JP-H01-106338A) and JP1989-79274A (JP-H01-79274A) can be referred to. As a dispersing device, a well-known dispersing device can be used. In any stage of preparing each layer forming composition, filtering may be performed by a well-known method. The filtering can be performed by using a filter, for example. As the filter used in the filtering, a filter having a pore diameter of 0.01 to 3 μm (for example, filter made of glass fiber or filter made of polypropylene) can be used, for example.

Coating Step

The magnetic layer can be formed by directly applying the magnetic layer forming composition onto the non-magnetic support surface or performing multilayer applying of the magnetic layer forming composition with the non-magnetic layer forming composition sequentially or simultaneously. The back coating layer can be formed by applying a back coating layer forming composition onto a surface of the non-magnetic support opposite to a surface having the non-magnetic layer and/or the magnetic layer (or to be provided with the non-magnetic layer and/or the magnetic layer). For details of the coating for forming each layer, a description disclosed in a paragraph 0066 of JP2010-231843A can be referred to. In a case where the magnetic tape is manufactured, the non-magnetic support is usually used in a machine direction (MD direction) as the longitudinal direction and a transverse direction (TD direction) as the width direction of the film.

Other Steps

Well-known technologies can be applied to other various steps for manufacturing the magnetic tape. Regarding the various steps, the descriptions disclosed in paragraphs 0067 to 0070 of JP2010-231843A can be referred to, for example. For example, a coating layer of the magnetic layer forming composition can be subjected to an alignment treatment while the coating layer is in a wet (undried) state. For the alignment treatment, the various well-known technologies including a description disclosed in a paragraph 0052 of JP2010-24113A can be used. For example, a vertical alignment treatment can be performed by a well-known method such as a method using a polar opposing magnet. In the alignment zone, a drying speed of the coating layer can be controlled depending on a temperature of dry air and an air volume and/or a transportation speed in the alignment zone. Further, the coating layer may be preliminarily dried before the transportation to the alignment zone.

Through various steps, a long magnetic tape original roll can be obtained. The obtained magnetic tape original roll is cut (slit) by a well-known cutter to have a width of the magnetic tape to be wound around the magnetic tape cartridge. The width is determined according to the standard and is, for example, ½ inches. 1 inch is 0.0254 meters.

For example, the magnetic tape original roll before slit is placed under a high temperature and a high humidity in a state where a high load is applied in the longitudinal direction (hereinafter, also referred to as “high-temperature and high-humidity load application treatment before slit”), whereby it is possible to obtain a magnetic tape having a deformation rate ratio within the range described above. Here, the high temperature may be, for example, an atmosphere temperature of 30° C. to 60° C., the high humidity may be, for example, a relative humidity of 40% to 100%, and the high load may be, for example, a load of 1.0 to 5.0 N. The load can be, for example, a load applied in the longitudinal direction of the magnetic tape original roll in a case where the magnetic tape original roll wound in a roll shape is rewound. The rewinding can be performed in a chamber in which an internal temperature and humidity can be controlled. For example, the magnetic tape original roll wound in a roll shape can be disposed in a chamber in a state where a temperature and a humidity are not controlled, and a load can be applied in the longitudinal direction to perform rewinding, and the temperature and the humidity in the chamber in which the magnetic tape original roll wound in a roll shape by the rewinding is disposed can be raised to hold the chamber in a high-temperature and high-humidity state for a predetermined time, and then the temperature and the humidity can be lowered. The above predetermined time may be, for example, 10 to 60 hours. After the above holding, the temperature and the humidity in the chamber may be lowered without rewinding, or the temperature and the humidity in the chamber may be lowered after rewinding under different loads. A temperature rising rate, a humidity rising rate, a temperature lowering rate, and a humidity lowering rate are not particularly limited. For example, the temperature rising rate may be 20 to 60° C./hour, the humidity rising rate may be 40 to 90%/hour, the temperature lowering rate may be 5 to 60° C./hour, and the humidity lowering rate may be 80 to 120%/hour.

It is possible to form a servo pattern in the manufactured magnetic tape by a well-known method in order to enable tracking control of the magnetic head in the magnetic recording and reproducing apparatus, control of a running speed of the magnetic tape, and the like. The term “formation of servo pattern” can also be referred to as “recording of servo signal”. The formation of the servo pattern will be described below.

The servo pattern is usually formed along a longitudinal direction of the magnetic tape. Examples of control (servo control) systems using a servo signal include a timing-based servo (TBS), an amplitude servo, and a frequency servo.

As shown in a European computer manufacturers association (ECMA)-319 (June 2001), a magnetic tape conforming to a linear tape-open (LTO) standard (generally called “LTO tape”) employs a timing-based servo system. In this timing-based servo system, the servo pattern is formed by continuously disposing a plurality of pairs of non-parallel magnetic stripes (also referred to as “servo stripes”) in the longitudinal direction of the magnetic tape. The servo system is a system that performs head tracking using servo signals. In the present invention and the present specification, the term “timing-based servo pattern” refers to a servo pattern that enables head tracking in a timing-based servo system. As described above, the reason why the servo pattern is formed of a pair of non-parallel magnetic stripes is to indicate, to a servo signal reading element passing over the servo pattern, a passing position thereof. Specifically, the pair of magnetic stripes is formed such that an interval thereof continuously changes along a width direction of the magnetic tape, and the servo signal reading element reads the interval to thereby sense a relative position between the servo pattern and the servo signal reading element. Information on this relative position enables tracking on a data track. Accordingly, a plurality of servo tracks are usually set on the servo pattern along the width direction of the magnetic tape.

A servo band is formed of a servo pattern continuous in the longitudinal direction of the magnetic tape. A plurality of the servo bands are usually provided on the magnetic tape. For example, in an LTO tape, the number of the servo bands is five. Regions interposed between two adjacent servo bands are data bands. The data band is formed of a plurality of data tracks and each data track corresponds to each servo track.

Further, in one aspect, as shown in JP2004-318983A, information indicating a servo band number (referred to as “servo band identification (ID)” or “unique data band identification method (UDIM) information”) is embedded in each servo band. This servo band ID is recorded by shifting a specific one of the plurality of pairs of the servo stripes in the servo band so that positions thereof are relatively displaced in the longitudinal direction of the magnetic tape. Specifically, a way of shifting the specific one of the plurality of pairs of servo stripes is changed for each servo band. Accordingly, the recorded servo band ID is unique for each servo band, and thus, the servo band can be uniquely specified only by reading one servo band with a servo signal reading element.

In a method of uniquely specifying the servo band, a staggered method as shown in ECMA-319 (June 2001) is used. In this staggered method, a group of pairs of non-parallel magnetic stripes (servo stripes) disposed continuously in plural in a longitudinal direction of the magnetic tape is recorded so as to be shifted in a longitudinal direction of the magnetic tape for each servo band. Since this combination of shifting methods between adjacent servo bands is unique throughout the magnetic tape, it is possible to uniquely specify a servo band in a case of reading a servo pattern with two servo signal reading elements.

As shown in ECMA-319 (June 2001), information indicating a position of the magnetic tape in the longitudinal direction (also referred to as “longitudinal position (LPOS) information”) is usually embedded in each servo band. This LPOS information is also recorded by shifting the positions of the pair of servo stripes in the longitudinal direction of the magnetic tape, as the UDIM information. Note that, unlike the UDIM information, in this LPOS information, the same signal is recorded in each servo band.

It is also possible to embed, in the servo band, the other information different from the above UDIM information and LPOS information. In this case, the embedded information may be different for each servo band as the UDIM information or may be common to all servo bands as the LPOS information.

As a method of embedding information in the servo band, it is possible to employ a method other than the above. For example, a predetermined code may be recorded by thinning out a predetermined pair from the group of pairs of servo stripes.

A head for forming a servo pattern is called a servo write head. The servo write head usually has a pair of gaps corresponding to the pair of magnetic stripes as many as the number of servo bands. Usually, a core and a coil are connected to each pair of gaps, and by supplying a current pulse to the coil, a magnetic field generated in the core can cause generation of a leakage magnetic field in the pair of gaps. In a case of forming the servo pattern, by inputting a current pulse while running the magnetic tape on the servo write head, the magnetic pattern corresponding to the pair of gaps is transferred to the magnetic tape to form the servo pattern. A width of each gap can be appropriately set according to a density of the servo pattern to be formed. The width of each gap can be set to, for example, 1 μm or less, 1 to 10 μm, 10 μm or more, and the like.

Before the servo pattern is formed on the magnetic tape, the magnetic tape is usually subjected to a demagnetization (erasing) treatment. This erasing treatment can be performed by applying a uniform magnetic field to the magnetic tape using a direct current magnet or an alternating current magnet. The erasing treatment includes direct current (DC) erasing and alternating current (AC) erasing. AC erasing is performed by gradually decreasing an intensity of the magnetic field while reversing a direction of the magnetic field applied to the magnetic tape. On the other hand, DC erasing is performed by applying a unidirectional magnetic field to the magnetic tape. As the DC erasing, there are two additional methods. A first method is horizontal DC erasing of applying a unidirectional magnetic field along a longitudinal direction of the magnetic tape. A second method is vertical DC erasing of applying a unidirectional magnetic field along a thickness direction of the magnetic tape. The erasing treatment may be performed on the entire magnetic tape or may be performed for each servo band of the magnetic tape.

A direction of the magnetic field of the servo pattern to be formed is determined according to a direction of the erasing. For example, in a case where the horizontal DC erasing is performed to the magnetic tape, the servo pattern is formed so that the direction of the magnetic field is opposite to the direction of the erasing. Therefore, an output of a servo signal obtained by reading the servo pattern can be increased. As shown in JP2012-53940A, in a case where the magnetic pattern is transferred to, using the gap, a magnetic tape that has been subjected to the vertical DC erasing, a servo signal obtained by reading the formed servo pattern has a monopolar pulse shape. On the other hand, in a case where a magnetic pattern is transferred to, using the gap, a magnetic tape that has been subjected to horizontal DC erasing, a servo signal obtained by reading the formed servo pattern has a bipolar pulse shape.

The magnetic tape is usually accommodated in a magnetic tape cartridge.

Magnetic Tape Cartridge

Another aspect of the present invention relates to a magnetic tape cartridge including the magnetic tape described above.

The details of the magnetic tape included in the above magnetic tape cartridge are as described above.

In the magnetic tape cartridge, generally, the magnetic tape is accommodated inside a cartridge body in a state of being wound around a reel. The reel is rotatably provided inside the cartridge body. As the magnetic tape cartridge, a single reel type magnetic tape cartridge having one reel inside the cartridge body and a dual reel type magnetic tape cartridge having two reels inside the cartridge body are widely used. In a case where the single reel type magnetic tape cartridge is mounted on a magnetic recording and reproducing apparatus for recording and/or reproducing data on the magnetic tape, the magnetic tape is pulled out of the magnetic tape cartridge to be wound around the reel on the magnetic recording and reproducing apparatus side. A magnetic head is disposed on a magnetic tape transportation path from the magnetic tape cartridge to a winding reel. Feeding and winding of the magnetic tape are performed between a reel (supply reel) on the magnetic tape cartridge side and a reel (winding reel) on the magnetic recording and reproducing apparatus side. During this time, for example, data is recorded and/or reproduced as the magnetic head and the magnetic layer surface of the magnetic tape come into contact with each other to be slid on each other. With respect to this, in the dual reel type magnetic tape cartridge, both reels of the supply reel and the winding reel are provided in the magnetic tape cartridge. The magnetic tape cartridge may be either a single reel type or dual reel type magnetic tape cartridge. The above magnetic tape cartridge need only include the magnetic tape according to one aspect of the present invention, and the well-known technology can be applied to the others.

Magnetic Recording and Reproducing Apparatus

Still another aspect of the present invention relates to a magnetic recording and reproducing apparatus comprising the magnetic tape described above.

In the present invention and the present specification, the term “magnetic recording and reproducing apparatus” means an apparatus capable of performing at least one of the recording of data on the magnetic tape or the reproduction of data recorded on the magnetic tape. Such an apparatus is generally called a drive. The magnetic recording and reproducing apparatus can be, for example, a sliding type magnetic recording and reproducing apparatus. The sliding type magnetic recording and reproducing apparatus is an apparatus in which the magnetic layer surface of the magnetic tape and the magnetic head come into contact with each other to be slid on each other, in a case of performing the recording of data on the magnetic tape and/or reproducing of the recorded data. For example, the magnetic recording and reproducing apparatus can attachably and detachably include the magnetic tape cartridge.

The magnetic recording and reproducing apparatus can include a magnetic head. The magnetic head can be a recording head capable of performing the recording of data on the magnetic tape, or can be a reproducing head capable of performing the reproducing of data recorded on the magnetic tape. In addition, in one aspect, the magnetic recording and reproducing apparatus can include both a recording head and a reproducing head as separate magnetic heads. In another aspect, the magnetic head included in the magnetic recording and reproducing apparatus can have a configuration in which both an element for recording data (recording element) and an element for reproducing data (reproducing element) are included in one magnetic head. Hereinafter, the element for recording and the element for reproducing data are collectively referred to as an “element for data”. As the reproducing head, a magnetic head (MR head) including a magnetoresistive (MR) element capable of sensitively reading data recorded on the magnetic tape as a reproducing element is preferable. As the MR head, various well-known MR heads such as an anisotropic magnetoresistive (AMR) head, a giant magnetoresistive (GMR) head, and a tunnel magnetoresistive (TMR) head can be used. In addition, the magnetic head which performs the recording of data and/or the reproduction of data may include a servo signal reading element. Alternatively, as a head other than the magnetic head which performs the recording of data and/or the reproduction of data, a magnetic head (servo head) comprising a servo signal reading element may be included in the magnetic recording and reproducing apparatus. For example, a magnetic head that records data and/or reproduces recorded data (hereinafter also referred to as “recording and reproducing head”) can include two servo signal reading elements, and the two servo signal reading elements can simultaneously read two adjacent servo bands. One or a plurality of elements for data can be disposed between the two servo signal reading elements.

In the magnetic recording and reproducing apparatus, recording of data on the magnetic tape and/or reproduction of data recorded on the magnetic tape can be performed, for example, as the magnetic layer surface of the magnetic tape and the magnetic head come into contact with each other to be slid on each other. The magnetic recording and reproducing apparatus need only include the magnetic tape according to one aspect of the present invention, and the well-known technology can be applied to the others.

For example, in a case of recording data and/or reproducing recorded data, first, head tracking can be performed using servo signals. That is, by causing the servo signal reading element to follow a predetermined servo track, the element for data can be controlled to pass on the target data track. Displacement of the data track is performed by changing a servo track read by the servo signal reading element in a tape width direction.

The recording and reproducing head can also perform recording and/or reproduction with respect to other data bands. In this case, the servo signal reading element need only be displaced to a predetermined servo band using the above described UDIM information to start tracking for the servo band.

### EXAMPLES

Hereinafter, the present invention will be described in more detail with reference to Examples. Note that the present invention is not limited to aspects shown in Examples. “Parts” and “%” in the following description mean “parts by mass” and “mass %”, unless otherwise noted. “eq” is an equivalent and is a unit that cannot be converted into an SI unit. The following steps and evaluations were performed in air at 23° C.±1° C., unless otherwise noted.

### Example 1

(1) Preparation of Alumina Dispersion A mixture in which 3.0 parts of 2,3-dihydroxynaphthalene (manufactured by Tokyo Chemical Industry Co., Ltd.), 31.3 parts of a 32% solution (solvent is a mixed solvent of methyl ethyl ketone and toluene) of a polyester polyurethane resin having a SO₃Na group as a polar group (UR-4800 manufactured by Toyobo Co., Ltd. (amount of a polar group: 80 meq/kg)), and 570.0 parts of a mixed solution of methyl ethyl ketone and cyclohexanone at 1:1 (mass ratio) as a solvent were mixed with respect to 100.0 parts of an alumina powder (HIT-80 manufactured by Sumitomo Chemical Co., Ltd.) having a pregelatinization ratio of about 65% and a Brunauer-Emmett-Teller (BET) specific surface area of 20 m²/g was put in a horizontal beads mill dispersing device together with zirconia beads having a bead diameter of 0.3 mm, “(bead volume/(volume of the above mixture+bead volume))×100” was adjusted to be 80%, and a beads mill dispersion treatment was performed for 120 minutes. The liquid after the beads mill dispersion treatment was taken out, and the taken-out liquid was subjected to an ultrasonic dispersion filtration treatment using a flow type ultrasonic dispersion filtration device. In this way, an alumina dispersion was prepared.

(2) Formulation of Magnetic Layer Forming Composition

| Magnetic liquid | |
|---|---|
| Ferromagnetic powder | 100.0 parts |
| Hexagonal barium ferrite powder having | 14.0 parts |
| average particle size (average plate | |
| diameter) of 21 nm (“BaFe” in Table 1) | |
| SO₃Na group-containing polyurethane resin | |
| Weight-average molecular weight: | |
| 70,000, SO₃Na group: 0.2 meq/g | |
| Cyclohexanone | 150.0 parts |
| Methyl ethyl ketone | 150.0 parts |
| Abrasive Liquid | |
| Alumina dispersion prepared in the section (1) | 6.0 parts |
| Silica Sol (Protrusion Forming Agent Liquid) | |
| Colloidal silica (average particle size: 120 nm) | 2.0 parts |
| Methyl ethyl ketone | 1.4 parts |
| Other Components | |
| Stearic acid | 2.0 parts |
| Stearic acid amide | 0.2 parts |
| Butyl stearate | 2.0 parts |
| Polyisocyanate (CORONATE (registered | 2.5 parts |
| trademark) L manufactured by Tosoh | |
| Corporation) | |
| Solvent-1 | |
| Cyclohexanone | 200.0 parts |
| Methyl ethyl ketone | 200.0 parts |
| Solvent-2 | |
| Cyclohexanone | 350.0 parts |
| Methyl ethyl ketone | 350.0 parts |

(3) Formulation of Non-Magnetic Layer Forming Composition

| | |
|---|---|
| Non-magnetic inorganic powder: α-iron oxide | 100.0 parts |
| Average particle size (average long axis length): 150 nm | |
| Average acicular ratio: 7 | |
| BET specific surface area: 52 m²/g | |
| Carbon black | 20.0 parts |
| Average particle size: 20 nmSO₃Na | 18.0 parts |
| group-containing polyurethane resin | |
| Weight-average molecular weight: | |
| 70,000, SO₃Na group: 0.2 meq/g | |
| Stearic acid | 2.0 parts |
| Stearic acid amide | 0.2 parts |
| Butyl stearate | 2.0 parts |
| Cyclohexanone | 300.0 parts |
| Methyl ethyl ketone | 300.0 parts |

(4) Preparation of Each Layer Forming Composition

The magnetic layer forming composition was prepared by the following method. The magnetic liquid was prepared by dispersing the above components for 24 hours (beads-dispersion) using a batch type vertical sand mill. As dispersion beads, zirconia beads having a bead diameter of 0.5 mm were used. The prepared magnetic liquid, the abrasive liquid, the silica sol, other components, and the solvent-1 were mixed using the sand mill, introduced into a dissolver stirrer, and stirred for 30 minutes at a circumferential speed of 10 m/sec, and then subjected to a 3-pass treatment at a flow rate of 7.5 kg/min using a flow type ultrasonic dispersing device. Thereafter, filtration was performed using a filter having a pore diameter of 0.5 μm, and then the solvent-2 was added to prepare a magnetic layer forming composition.

A non-magnetic layer forming composition was prepared by the following method. The components described above excluding the lubricant (stearic acid, stearic acid amide, and butyl stearate) were kneaded and diluted by an open kneader, and subjected to a dispersion treatment by a horizontal beads mill dispersing device. After that, the lubricant (stearic acid, stearic acid amide, and butyl stearate) was added into the obtained dispersion liquid and stirred and mixed by a dissolver stirrer to prepare a non-magnetic layer forming composition.

A back coating layer forming composition was prepared by diluting the composition prepared by the method described for the non-magnetic layer forming composition by adding the following solvent.

| | |
|---|---|
| Cyclohexanone | 300.0 parts |
| Methyl ethyl ketone | 300.0 parts |

(5) Manufacturing Method of Magnetic Tape

The non-magnetic layer forming composition was applied onto a surface of a commercially available polyethylene naphthalate support having a thickness of 4.6 μm and was dried so that the thickness after drying was 0.7 μm, and thus a non-magnetic layer was formed.

Next, the magnetic layer forming composition was applied onto a surface of the non-magnetic layer and was dried so that the thickness after drying was 0.1 μm, and thus a magnetic layer was formed.

After that, the back coating layer forming composition was applied onto a surface of the support opposite to the surface on which the non-magnetic layer and the magnetic layer are formed and was dried so that the thickness after drying was 0.5 μm, and thus, a back coating layer was formed.

Thereafter, a surface smoothing treatment (calendering treatment) was performed twice using a calender roll formed of two metal rolls at a speed of 100 m/min, a linear pressure of 294 kN/m (300 kg/cm), and a calender temperature of 95° C. (surface temperature of calender roll), and after that, a heat treatment was performed by storing the original roll in a heat treatment furnace at the atmosphere temperature in the furnace of 70° C. for 40 hours, and the original roll was wound in a roll shape by applying a load of 0.3 N in the longitudinal direction.

The magnetic tape original roll (length 5500 m) after being wound in a roll shape in this way was subjected to a high-temperature and high-humidity load application treatment before slit by the method described below.

The magnetic tape original roll after being wound in a roll shape was disposed in a chamber in which an internal temperature and humidity in the chamber can be controlled, and rewinding was performed by applying a load of 3.0 N in the longitudinal direction (“Load applied in longitudinal direction” in Table 1) without controlling the temperature and the humidity in the chamber. Without control over the temperature and the humidity, the temperature in the chamber was 25° C. and the relative humidity was 30%.

The temperature and the humidity in the chamber in which the magnetic tape original roll wound in a roll shape by the rewinding was disposed were raised to the temperature in the chamber and the relative humidity in the chamber shown in Table 1 at the temperature rising rate and the humidity rising rate shown in Table, and then held for 48 hours. Since the above-described temperature rise and humidity rise was performed after rewinding under the above-described load applied in longitudinal direction, “Present” was indicated in the row of “Load during temperature rise and humidity rise in chamber” in Table 1.

Next, after the magnetic tape original roll was rewound in the chamber having the temperature in the chamber and the relative humidity in the chamber shown in Table 1 under a load of 0.3 N (“Load during temperature lowering and humidity lowering in chamber” in Table 1) in the longitudinal direction, the temperature and the humidity in the chamber in which the magnetic tape original roll wound in a roll shape by this rewinding was disposed were lowered to a temperature of 25° C. and a relative humidity of 30% at the temperature lowering rate and the humidity lowering rate shown in Table 1.

The magnetic tape original roll taken out from the chamber was slit to have ½ inches (1 inch=0.0254 m) width, and the magnetic layer surface was cleaned by a tape cleaning device attached to a device having a feeding and winding device for a slit product such that a non-woven fabric and a razor blade press against the magnetic layer surface. Then, a servo pattern (timing-based servo pattern) in an arrangement and a shape according to the LTO Ultrium format was formed in the magnetic layer by a commercially available servo writer. In a state of being wound in a roll shape after the high-temperature and high-humidity load application treatment before slit, the end part of the magnetic tape original roll on the winding reel side is referred to as a 0 m position, the other end part thereof is referred to as a 5500 m position, the side from the end part at the 5500 m position to the end part at the 0 m position is referred to as an inside, and the other side is referred to as an outside. Then, a region having a length of 1100 m and extending from a 5400 m position of the magnetic tape after formation of the servo pattern to the inside in the longitudinal direction was cut out, and a magnetic tape having a length of 1100 m was obtained. This magnetic tape was wound around a reel of a single reel type magnetic tape cartridge and accommodated in the magnetic tape cartridge.

From the above, the magnetic tape cartridge of Example 1 was manufactured.

### Examples 2 to 7 and Comparative Example 1

A magnetic tape cartridge was manufactured by the method described for Example 1 except that various items were changed as shown in Table 1.

In Examples 3 and 4, as described in Example 1, the high-temperature and high-humidity load application treatment before slit was performed on the magnetic tape original roll after being wound in a roll shape under a load of 0.3 N in the longitudinal direction as follows.

The magnetic tape original roll after being wound in a roll shape was disposed in a chamber in which an internal temperature and humidity in the chamber can be controlled, and rewinding was performed by applying a load of 3.0 N in the longitudinal direction (“Load applied in longitudinal direction” in Table 1) without controlling the temperature and the humidity in the chamber. Without control over the temperature and the humidity, the temperature in the chamber was 25° C. and the relative humidity was 30%.

The temperature and the humidity in the chamber in which the magnetic tape original roll wound in a roll shape by the rewinding was disposed were raised to the temperature in the chamber and the relative humidity in the chamber shown in Table 1 at the temperature rising rate and the humidity rising rate shown in Table, and then held for 48 hours. Since the above-described temperature rise and humidity rise was performed after rewinding under the above-described load applied in longitudinal direction, “Present” was indicated in the row of “Load during temperature rise and humidity rise in chamber” in Table 1.

After the holding, the temperature and the humidity in the chamber were lowered to a temperature of 25° C. and a relative humidity of 30% at the temperature lowering rate and the humidity lowering rate shown in Table 1, and then a load of 0.3 N was applied in the longitudinal direction to rewind the magnetic tape original roll. Since the rewinding was not performed before lowering the temperature and the humidity, the same value as the row of “Load applied in longitudinal direction” was described in the row of “Load during temperature lowering and humidity lowering in chamber” in Table 1.

For Example 5, the magnetic tape having a length of 1100 m accommodated in the magnetic tape cartridge was acquired by cutting out a region having a length of 1100 m and extending from the 100 m position to the outside in the longitudinal direction.

For Comparative Example 1, the high-temperature and high-humidity load application treatment before slit was not performed.

For Examples 1 to 7 and Comparative Example 1, two magnetic tape cartridges were prepared, one of which was used for the deformation rate ratio measurement described below, and the other of which was used for the error rate evaluation in the post-storage drive described below.

Method of Producing Ferromagnetic Powder

Method of Producing Hexagonal Strontium Ferrite Powder

“SrFe” shown in Table 1 is hexagonal strontium ferrite powder manufactured by the following method.

1707 g of SrCO₃, 687 g of H₃BO₃, 1120 g of Fe₂O₃, 45 g of Al(OH)₃, 24 g of BaCO₃, 13 g of CaCO₃, and 235 g of Nd₂O₃ were weighed and mixed by a mixer to obtain a raw material mixture.

The obtained raw material mixture was melted in a platinum crucible at a melting temperature of 1390° C., and a hot water outlet provided at a bottom of the platinum crucible was heated while stirring a melt, and the melt was discharged in a rod shape at about 6 g/sec. Hot water was rolled and quenched by a pair of water-cooling rollers to manufacture an amorphous body.

280 g of the manufactured amorphous body was charged into an electric furnace, was heated to 635° C. (crystallization temperature) at a temperature rising rate of 3.5° C./min, and was kept at the same temperature for 5 hours to precipitate (crystallize) hexagonal strontium ferrite particles.

Next, a crystallized product obtained above including hexagonal strontium ferrite particles was coarsely pulverized in a mortar, and 1000 g of zirconia beads having a particle diameter of 1 mm and 800 mL of an acetic acid aqueous solution of 1% concentration were added to the crystallized product in a glass bottle, to be dispersed by a paint shaker for 3 hours. Thereafter, the obtained dispersion liquid was separated from the beads, to be put in a stainless beaker. The dispersion liquid was statically left at a liquid temperature of 100° C. for 3 hours and subjected to a dissolving treatment of a glass component, and then the crystallized product was sedimented by a centrifugal separator to be washed by repeatedly performing decantation and was dried in a heating furnace at an internal temperature of the furnace of 110° C. for 6 hours to obtain a hexagonal strontium ferrite powder.

An average particle size of the hexagonal strontium ferrite powder obtained above was 18 nm, an activation volume was 902 nm³, an anisotropy constant Ku was 2.2×10⁵ J/m³, and a mass magnetization σs was 49 A·m²/kg.

12 mg of a sample powder was taken from the hexagonal strontium ferrite powder obtained above, elemental analysis of the filtrated solution obtained by partially dissolving this sample powder under dissolution conditions illustrated above was performed by an ICP analyzer, and a surface layer portion content of a neodymium atom was determined.

Separately, 12 mg of a sample powder was taken from the hexagonal strontium ferrite powder obtained above, elemental analysis of the filtrated solution obtained by totally dissolving this sample powder under dissolution conditions illustrated above was performed by an ICP analyzer, and a bulk content of a neodymium atom was determined.

A content (bulk content) of a neodymium atom with respect to 100 at % of an iron atom in the hexagonal strontium ferrite powder obtained above was 2.9 at %. A surface layer portion content of a neodymium atom was 8.0 at %. It was confirmed that a ratio between a surface layer portion content and a bulk content, that is, “surface layer portion content/bulk content” was 2.8, and a neodymium atom was unevenly distributed in a surface layer of a particle.

The fact that the powder obtained above shows a crystal structure of hexagonal ferrite was confirmed by performing scanning with CuKα rays under conditions of a voltage of 45 kV and an intensity of 40 mA and measuring an X-ray diffraction pattern under the following conditions (X-ray diffraction analysis). The powder obtained above showed a crystal structure of hexagonal ferrite of a magnetoplumbite type (M type). A crystal phase detected by X-ray diffraction analysis was a single phase of a magnetoplumbite type.

PANalytical X'Pert Pro diffractometer, PIXcel detector

Soller slit of incident beam and diffracted beam: 0.017 radians

Fixed angle of dispersion slit: ¼ degrees

Mask: 10 mm

Anti-scattering slit: ¼ degrees

Measurement mode: continuous

Measurement time per stage: 3 seconds

Measurement speed: 0.017 degrees per second

Measurement step: 0.05 degrees

Method of Producing ε-Iron Oxide Powder

“ε-iron oxide” shown in Table 1 is ε-iron oxide powder manufactured by the following method.

8.3 g of iron(III) nitrate nonahydrate, 1.3 g of gallium(III) nitrate octahydrate, 190 mg of cobalt(II) nitrate hexahydrate, 150 mg of titanium(IV) sulfate, and 1.5 g of polyvinylpyrrolidone (PVP) were dissolved in 90 g of pure water, and while the dissolved product was stirred using a magnetic stirrer, 4.0 g of an aqueous ammonia solution having a concentration of 25% was added to the dissolved product under a condition of an atmosphere temperature of 25° C. in an air atmosphere, and the dissolved product was stirred for 2 hours while maintaining a temperature condition of the atmosphere temperature of 25° C. A citric acid aqueous solution obtained by dissolving 1 g of citric acid in 9 g of pure water was added to the obtained solution, and the mixture was stirred for 1 hour. The powder sedimented after stirring was collected by centrifugal separation, was washed with pure water, and was dried in a heating furnace at a furnace temperature of 80° C.

800 g of pure water was added to the dried powder, and the powder was dispersed again in water to obtain dispersion liquid. The obtained dispersion liquid was heated to a liquid temperature of 50° C., and 40 g of an aqueous ammonia solution having a concentration of 25% was dropwise added with stirring. After stirring for 1 hour while maintaining the temperature at 50° C., 14 mL of tetraethoxysilane (TEOS) was dropwise added and was stirred for 24 hours. A powder sedimented by adding 50 g of ammonium sulfate to the obtained reaction solution was collected by centrifugal separation, was washed with pure water, and was dried in a heating furnace at a furnace temperature of 80° C. for 24 hours to obtain a ferromagnetic powder precursor.

The obtained ferromagnetic powder precursor was loaded into a heating furnace at a furnace temperature of 1000° C. in an air atmosphere and was heat-treated for 4 hours.

The heat-treated ferromagnetic powder precursor was put into an aqueous solution of 4 mol/L sodium hydroxide (NaOH), and the liquid temperature was maintained at 70° C. and was stirred for 24 hours, whereby a silicic acid compound as an impurity was removed from the heat-treated ferromagnetic powder precursor.

Thereafter, the ferromagnetic powder from which the silicic acid compound was removed was collected by centrifugal separation, and was washed with pure water to obtain a ferromagnetic powder.

The composition of the obtained ferromagnetic powder that was checked by high-frequency inductively coupled plasma-optical emission spectrometry (ICP-OES) has Ga, Co, and a Ti substitution type ε-iron oxide (ε-Ga_{0.28}Co_{0.05}Ti_{0.05}Fe_{1.62}O₃). In addition, X-ray diffraction analysis is performed under the same condition as that described above for the manufacturing method of hexagonal strontium ferrite powder, and from a peak of an X-ray diffraction pattern, it is checked that the obtained ferromagnetic powder does not include α-phase and γ-phase crystal structures, and has a single-phase and 8-phase crystal structure (ε-iron oxide crystal structure).

The obtained ε-iron oxide powder had an average particle size of 12 nm, an activation volume of 746 nm³, an anisotropy constant Ku of 1.2×10⁵ J/m³, and a mass magnetization σs of 16 A·m²/kg.

An activation volume and an anisotropy constant Ku of the above hexagonal strontium ferrite powder and ε-iron oxide powder are values obtained by the method described above using a vibrating sample magnetometer (manufactured by Toei Industry Co., Ltd.) for each ferromagnetic powder.

In addition, a mass magnetization σs is a value measured at a magnetic field intensity of 1194 kA/m (15 kOe) using a vibrating sample magnetometer (manufactured by Toei Industry Co., Ltd.).

Evaluation Method

(1) Deformation Rate ratio

As a measuring device, a measuring device (TDSMS 102H) manufactured by Measurement Analysis Corporation (U.S.A) was used, and the deformation rate in the longitudinal direction and the deformation rate in the width direction after applying a load in the longitudinal direction of the magnetic tape for 96 hours were obtained by the method described above. The dimensions in the width direction and the longitudinal direction were measured by a laser scan micrometer attached to the measuring device. The deformation rate ratio (the deformation rate in the width direction/the deformation rate in the longitudinal direction) was calculated from the deformation rate in the width direction and the deformation rate in longitudinal direction of the magnetic tape obtained in this way.

(2) Reference Value: Deformation Rate Ratio (Short-Time Evaluation)

In order to show that a measured value for a phenomenon observed in a short time, which is generally called a Poisson's ratio, does not correlate with the above-described deformation rate ratio, the deformation rate ratio for short-time evaluation was obtained as a reference value by the following method.

The measurement was performed in a measurement environment of an atmosphere temperature of 32° C. and a relative humidity of 65%.

A tape piece having a length of 600 mm cut out from any position of the magnetic tape cartridge after being stored in the storage environment in the measurement by the method described above in the section (1) was set in the measuring device used in the section (1) above, and held in a state where a load of 0.2 N was applied in the longitudinal direction of the tape piece after 30 minutes had elapsed since an atmosphere temperature and a relative humidity of an environment in which the measuring device was placed reached the atmosphere temperature of 32° C. and relative humidity of 65%. A dimension in the width direction and a dimension in the longitudinal direction of the tape piece were measured by a laser scan micrometer attached to the measuring device when 30 minutes have elapsed with a start time of the application of a load of 0.2 N set to 0 minutes. The dimension in the width direction measured here is defined as an initial value “W_{ref(0)}” in the width direction, and the dimension in the longitudinal direction is defined as an initial value “L_{ref(0)}” in the longitudinal direction. These units are mm. ref is an abbreviation for reference.

After 30 minutes had elapsed since the start time of the application a load of 0.2 N, the dimension in the width direction and the dimension in the longitudinal direction were measured over time by a laser scan micrometer attached to the measuring device while the load applied in the longitudinal direction was changed from 0.2 N to a final load of 1.0 N at a deformation rate of 20 μm/sec. The number of measurement points during the above-described measurement over time was 20 or more.

The dimension in the width direction of the magnetic tape at time t during the applied load change is denoted by “W_{ref(t)}”, and the dimension in the longitudinal direction is denoted by “L_{ref(t)}”. These units are mm.

With time t as a parameter, a value of a in the least-squares calculation using a linear equation Y=a×X+b for the (X,Y) group in which (X,Y)=(L_{ref(t)}/L_{ref(0)},W_{ref(t)}/W_{ref(0)}) was used as the deformation rate ratio for short-time evaluation of the reference value.

(3) Error Rate Evaluation in Post-Storage Drive

Each of the magnetic tape cartridges of Examples 1 to 7 and Comparative Example 1 was set in a drive (magnetic recording and reproducing apparatus), and signals were recorded in the longitudinal direction of the magnetic tape while performing head tracking using servo signals so that winding stress (tension applied per cross-sectional area of the tape) in the longitudinal direction of the tape was 10 MPa (megapascal), and an error rate during this recording was measured by a measuring device attached to the drive.

After the magnetic tape cartridge accommodating the magnetic tape after the recording was stored for 3 months in a storage environment of an atmosphere temperature of 32° C. and a relative humidity of 65%, the magnetic tape cartridge was set again in a drive (magnetic recording and reproducing apparatus), and the magnetic tape was run in the drive so that the winding stress in the longitudinal direction of the tape was 10 MPa, and the signal recorded on the magnetic tape was reproduced while performing head tracking using servo signals, and an error rate during reproduction was measured by a measuring device attached to the drive.

In Table 1, a case where the error rate increased in running after storage compared to before storage is indicated as “Increasing”, and a case where the error rate did not increase compared to before storage is indicated as “Not increasing”.

Table 1 shows results of the above evaluations.

TABLE 1

| Comparative | Example | Example | Example | Example | Example | Example | Example |
|---|---|---|---|---|---|---|---|
| Example 1 | 1 | 2 | 3 | 4 | 5 | 6 | 7 |

| | | | |
|---|---|---|---|
| Ferromagnetic powder | BaFe | SrFe | ε-Iron |
| | | | oxide |

| Non-magnetic support | | Polyethylene naphthalate support | | | |
|---|---|---|---|---|---|
| Conditions of | Load applied in | Absent | 3.0 | | |
| high-temperature | longitudinal direction (N) | | | | |
| and | Temperature in chamber | | 30 | 50 | 30 |
| high-humidity | (° C.) | | | | |
| load application | Relative humidity in | | 50 | 80 | 50 |
| treatment before | chamber (%) | | | | |
| slit | Load during temperature | | Present | | |
| | rise and humidity rise in | | | | |
| | chamber | | | | |
| | Temperature rising rate | | 30 | 50 | 30 |
| | in chamber (° C./hour) | | | | |
| | Humidity rising rate in | | 50 | 80 | 50 |
| | chamber (%/hour) | | | | |

| | | | | |
|---|---|---|---|---|
| Load during temperature | 0.3 | 3.0 | 0.3 | 0.3 |
| lowering and humidity | | | | |
| lowering in chamber (N) | | | | |

| | |
|---|---|
| Temperature lowering | 10 |
| rate in chamber | |
| (° C./hour) | |
| Humidity lowering rate | 100 |
| in chamber (%/hour) | |

| | | | | | | | | |
|---|---|---|---|---|---|---|---|---|
| Reference value: deformation rate ratio | 0.27 | 0.27 | 0.28 | 0.28 | 0.27 | 0.27 | 0.28 | 0.27 |
| (short-time evaluation) | | | | | | | | |
| (1) Deformation rate in longitudinal | 70 | 67 | 65 | 80 | 95 | 31 | 66 | 67 |
| direction of magnetic tape (ppm) | | | | | | | | |
| (2) Deformation rate in width direction of | 30 | 27 | 15 | 18 | 18 | 10 | 26 | 26 |
| magnetic tape (ppm) | | | | | | | | |
| Deformation rate ratio: (2)/(1) | 0.43 | 0.40 | 0.23 | 0.23 | 0.19 | 0.32 | 0.39 | 0.39 |
| Error rate evaluation in post-storage drive | Increasing | Not | Not | Not | Not | Not | Not | Not |
| | | increasing | increasing | increasing | increasing | increasing | increasing | increasing |

From the results shown in Table 1, it can be confirmed that in Examples 1 to 7, in the reproduction of the data on the magnetic tape after storage, the data recorded before storage could be reproduced satisfactorily by suppressing the occurrence of reproduction failure. According to such a magnetic tape, even in a case of recording data after storage, it is possible to suppress the occurrence of recording failure such as overwriting of the data recorded before storage and to perform recording satisfactorily.

From the comparison between the deformation rate ratio shown in Table 1 and the reference value (the deformation rate ratio for short-time evaluation), it can be confirmed that the deformation rate ratio shown in Table 1 does not correlate with the reference value.

One aspect of the present invention is useful for various data storage applications such as data backup and archiving.

What is claimed is:

1. A magnetic tape comprising:
a non-magnetic support; and
a magnetic layer including a ferromagnetic powder,
wherein the non-magnetic support is a polyethylene naphthalate support, and
a deformation rate ratio of a deformation rate in a width direction to a deformation rate in a longitudinal direction of the magnetic tape, which is expressed by the deformation rate in the width direction/the deformation rate in the longitudinal direction, is 0.42 or less, the deformation rates each being measured after a load is applied in the longitudinal direction of the magnetic tape for 96 hours.

2. The magnetic tape according to claim 1,
wherein the deformation rate ratio is 0.15 or more and 0.42 or less.

3. The magnetic tape according to claim 1, further comprising:
a non-magnetic layer including a non-magnetic powder between the non-magnetic support and the magnetic layer.

4. The magnetic tape according to claim 1, further comprising:
a back coating layer including a non-magnetic powder on a surface side of the non-magnetic support opposite to a surface side having the magnetic layer.

5. The magnetic tape according to claim 1,
wherein the ferromagnetic powder is a hexagonal barium ferrite powder.

6. The magnetic tape according to claim 1,
wherein the ferromagnetic powder is a hexagonal strontium ferrite powder.

7. The magnetic tape according to claim 1,
wherein the ferromagnetic powder is an ε-iron oxide powder.

8. A magnetic tape cartridge comprising:
the magnetic tape according to claim 1.

9. The magnetic tape cartridge according to claim 8,
wherein the deformation rate ratio is 0.15 or more and 0.42 or less.

10. The magnetic tape cartridge according to claim 8,
wherein the ferromagnetic powder is a hexagonal barium ferrite powder.

11. The magnetic tape cartridge according to claim 8,
wherein the ferromagnetic powder is a hexagonal strontium ferrite powder.

12. The magnetic tape cartridge according to claim 8,
wherein the ferromagnetic powder is an ε-iron oxide powder.

13. A magnetic recording and reproducing apparatus comprising:
the magnetic tape according to claim 1.

14. The magnetic recording and reproducing apparatus according to claim 13,
wherein the deformation rate ratio is 0.15 or more and 0.42 or less.

15. The magnetic recording and reproducing apparatus according to claim 13,
wherein the ferromagnetic powder is a hexagonal barium ferrite powder.

16. The magnetic recording and reproducing apparatus according to claim 13,
wherein the ferromagnetic powder is a hexagonal strontium ferrite powder.

17. The magnetic recording and reproducing apparatus according to claim 13,
wherein the ferromagnetic powder is an ε-iron oxide powder.
